(19) United States
(12) Patent Application Publication
(10) Pub. No.: US 2004/0247917 A1
(43) Pub. Date: Dec. 9, 2004

(54) Paper-laminated articles of manufacture and method

(75) Inventor: Antonio M. Mendes, Round Rock, TX (US)

Correspondence Address: MARSHALL, GERSTEIN & BORUN LLP, 6300 SEARS TOWER, 233 S. WACKER DRIVE, CHICAGO, IL, 60606, US

(73) Assignee: INTERCRAFT D/B/A BURNES GROUP, Austin, TX

(21) Appl. No.: 10/856,533

(22) Filed: May 28, 2004

Related U.S. Application Data
(60) Provisional application No. 60/474,667, filed on May 30, 2003.

(51) Int. Cl. B05D 3/02

(52) U.S. Cl. 428/530; 427/458; 427/421.1; 427/429; 428/179

(57) ABSTRACT

Molded wood-based decorative articles can be prepared by first laminating a paper sheet to a shaped, wood-based substrate, e.g., natural wood or a man-made board, preferably fiberboard, prior to applying a moldable cellulosic composition over at least one outer surface of the paper overlay. Surprisingly, the moldable cellulosic composition has excellent adherence to the paper overlay, so long as the paper does not have an anti-stick coating, such as a silicone or other lubricious surface treatment. The preferred paper is kraft paper that has no surface coating. After adhering the paper to the shaped, wood-based article, the moldable cellulose-based composition is applied to one or more outer surfaces of the paper overlay in a thickness of preferably in the range of 1/32 inch to 1.0 inch and the cellulosic composition then is molded to form a decorative pattern on one or more outer surfaces of the paper overlay. The article then is coated with a decorative coating material, such as a water-or oil-based paint or powder coating, single or multiple coats, over both the molded cellulosic composition and paper overlay to provide exceptional aesthetics.

### FIELD OF THE INVENTION

The present invention is directed to decorative, embossed, laminated wood-based articles of manufacture, such as picture frames, door and cabinet moldings, home wall moldings, such as trim molding, baseboard moldings, case moldings, chair rails, corner trim materials, stair moldings, and the like; and methods of manufacturing. More particularly, in one embodiment, the articles and methods described herein are manufactured by securing an overlay of a paper sheet to a shaped wood-based material, such as fiberboard; applying a coating of moldable cellulosic material over a portion of the paper sheet; molding the cellulosic material to provide an embossed pattern in the cellulosic material; and then applying a decorative coating, e.g., a paint to the embossed pattern and the paper sheet. The articles then can be secured together to form a rectangular picture frame, or secured to a wall, door or cabinet, as decorative trim. In another embodiment, metallic powder coatings are applied directly to paper-coated substrates by pre-heating the substrates for better adherence of the metallic coatings.

### BACKGROUND

One method of manufacturing decorative articles, such as antique finishes on wood-based, embossed picture frames, has been to coat one or more surfaces of a shaped, man-made board, such as a medium density fiberboard (MDF), with a composition of finely divided cellulosic fibers, e.g., wood dust particles and an adhesive in a volatile solvent, such as acetone (commonly referred to in the art as “Compo”) over one or more surfaces of the man-made board; emboss the cellulosic composition with a decorative pattern; and then paint the entire article, or that portion of the article that will be visible, e.g., the outer surface of a molding or picture frame. One of the problems with this manufacturing method is that the man-made board has a fibrous, rough surface that is difficult to mask, e.g., with a paint or other coating material, without applying the coating material in such a thick coating that the embossing details molded into the Compo are blurred. Further, the relatively smooth surface of the embossed cellulosic composition are visually distinguishable from relatively rough man-made board surfaces in such prior art articles. These problems are overcome in accordance with the articles and manufacturing methods described herein.

### SUMMARY

In accordance with the improved articles and methods of manufacture described herein it has been found that greatly improved molded wood-based decorative articles can be prepared by first laminating a paper sheet to a shaped, wood-based substrate, e.g., natural wood or a man-made board, preferably fiberboard, prior to applying a moldable cellulosic composition over at least one outer surface of the paper overlay. Surprisingly, the moldable cellulosic composition has excellent adherence to the paper overlay, so long as the paper does not have an anti-stick coating, such as a silicone or other lubricious surface treatment. The preferred paper is kraft paper that has no surface coating. After adhering the paper to the shaped, wood-based article, the moldable cellulose-based composition is applied to one or more outer surfaces of the paper overlay in a thickness of preferably in the range of 1/32 inch to 1.0 inch and the cellulosic composition then is molded to form a decorative pattern on one or more outer surfaces of the paper overlay. The article then is coated with a decorative coating material, such as a water-or oil-based paint or powder coating, single or multiple coats, over both the molded cellulosic composition and paper overlay to provide exceptional aesthetics.

Accordingly, one aspect of the articles and methods described herein is to provide a molded, wood-based article suitable for the manufacture of picture frames, wall moldings, door moldings, crown moldings, and/or the like that is a composite material manufactured to include a layer of a moldable cellulosic material applied over an adhered paper overly that is disposed on a rigid substrate, wherein the cellulosic material is embossed after adherence to the paper overlay, whereby the paper overlay and embossed cellulosic material are coated with a decorative coating, e.g., a paint or powder film or layer, to provide a homogeneous surface finish.

Another aspect of the present invention is to provide a decorative molding or frame article comprising a rigid substrate having a paper layer secured thereto that is decoratively coated with a metal powder coating material by pre-heating the paper-coated substrate to a temperature of about 185° F. to about 375° F., preferably about 200° F. to about 235° F. for surprisingly good adherence of the metallic powder coating material to the paper overlay and/or to an embossed cellulosic material layer.

The above and other aspects and advantages will become apparent from the following detailed description of the preferred embodiments, taken in conjunction with the drawings.

### BRIEF DESCRIPTION OF THE DRAWINGS

FIG. 1 is a partially broken-away perspective view of the article and method of manufacturing described herein; and

FIG. 2 is a partially broken-away perspective view of a decorative powder coating method.

### DETAILED DESCRIPTION OF THE PREFERRED EMBODIMENTS

The wood-based articles, in one embodiment, described herein, are prepared by applying a layer of finally divided wood dust, glue and volatile solvent over a wood-based, shaped substrate having a adhered layer of paper therebetween. While others have applied this cellulosic composition on a layer of at least one surface of the wood-based substrate, a major problem with such a method of manufacture is that the application of a final, decorative coating, e.g., paint, thereover, has resulted in a distinct visual difference between the coating applied to the cellulosic composition and the coating applied to a wood-based substrate, such as medium density fiberboard (MDF). Surprisingly, it has been found that by adhering a paper overlay onto a shaped substrate, such as by applying a layer of hot-melted adhesive, followed by the application of a moldable layer, e.g., 1/32 inch to 1 inch, preferably 1/16 inch to ¾ inch in thickness that is subsequently molded to a decorative pattern, the embossed or molded cellulosic composition disposed on top of the paper overlay and the paper layer will provide the same visual surface finish when both are coated with a decorative coating such as a paint or powder coating as a final manufacturing step. In another embodiment, an uncoated paper layer is adhered to a substrate and the paper-laminated substrate is pre-heated for surprisingly better adherence of a metallic powder decorative coating over the laminated paper layer.

### THE UNDERLYING SHAPED SUBSTRATE

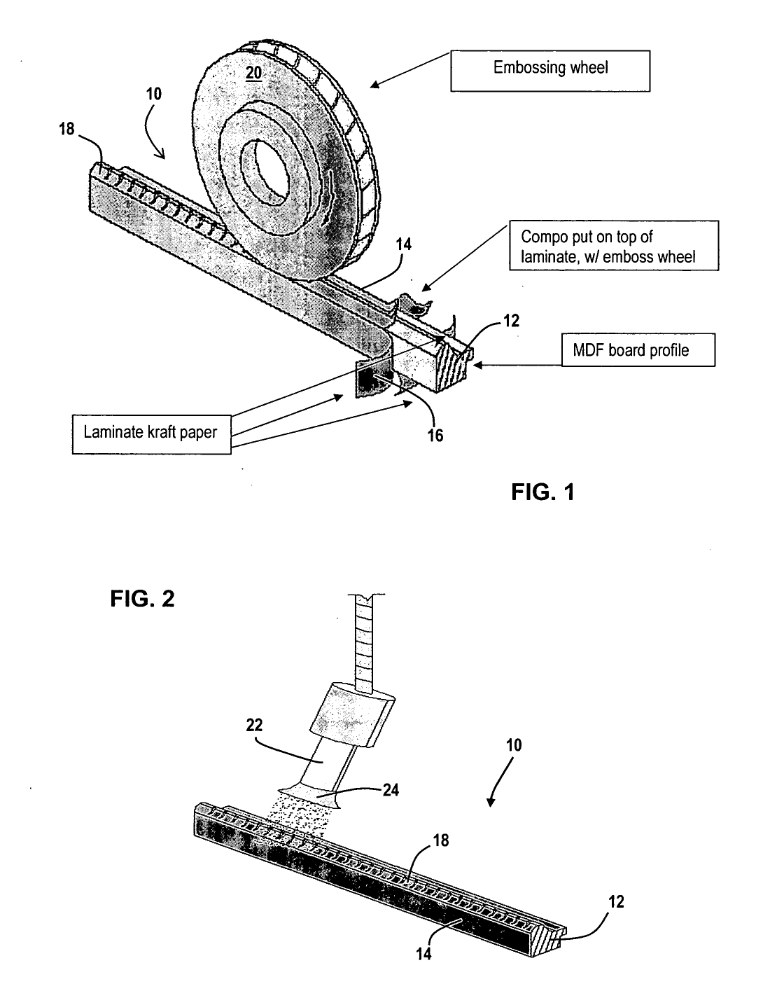

Since the underlying substrate is coated with a paper layer, the material of the underlying shaped substrate is of no consequence other than providing a substrate that has sufficient structural integrity for its intended use. Additionally, the shaped substrate should be such that a sheet of uncoated kraft paper can be adhered thereto and remain intact over the intended period of use. The preferred underlying shaped substrate is made of a fiberboard, particularly a medium density fiberboard (MDF), such as Eugene MDF from Willamette Industries, Inc. The substrate could also be formed from a foam material such as polyurethane foam, milled natural wood, metal, plastic, such as polyethylene, polypropylene, nylon, and any other polymeric material that has sufficient structural integrity. The preferred substrate is a medium density fiberboard that is milled into a suitable profile, such as one side of a picture frame 10, as shown in FIG. 1. For application of powder coatings, the paper coated substrate is pre-heated to about 185° F. to about 375° F., preferably about 200° F. to about 235° F. so that if the substrate is a polymer, it should be thermosetting or otherwise capable of withstanding the pre-heating temperature.

### PAPER OVERLAY

As shown in the drawing, the profiled medium density fiberboard 12 has a sheet of uncoated kraft paper 14 having a basis of about 30 to about 70 g/m², preferably about 40 to about 55 g/m², adhered to the medium density fiberboard 12 with any suitable adhesive, preferably a hot melt adhesive 16.

### MOLDABLE CELLULOSIC COMPOSITION (COMPO)

After adhering the paper layer 14 over the shaped substrate 12 with a suitable adhesive 16 a moldable layer of any thickness of a composition 18 that includes finally divided cellulosic fibers, e.g., wood dust, containing a suitable cellulosic adhesive or cellulosic binding resin and a volatile solvent such as acetone is coated in a suitable thickness over at least one surface of the paper coated substrate so that the cellulosic composition can be molded or embossed to provide a decorative pattern within the cellulosic composition. A suitable cellulosic composition is sold by RPM Wood Finishes Group as product M60I0046 HC#14010 VER. This cellulosic composition has the following composition:

| Chemical Name | CASRN | Wt. % |
|---|---|---|
| acetone | 67-64-1 | 50.91 |
| Cellulose | 9004-34-6 | 28.66 |
| Polyvinyl acetate | 9003-20-7 | 14.22 |
| Oil | 8001-25-0 | 6.21 |

Preferably, the cellulosic composition contains finely divided cellulose particles in an amount of about 15 to about 40% by weight, preferably about 20 to about 35% by weight, more preferably about 25 to about 35% by weight; a volatile solvent, such as acetone, in an amount of about 40 to about 70% by weight, preferably about 45 to about 60% by weight, more preferably about 50 to about 55% by weight; and an adhesive or adhesive resin such as polyvinyl acetate in an amount of about 5 to about 30% by weight, preferably about 10 to about 25% by weight, more preferably about 10 to about 20% by weight.

Preferably, in one embodiment, a cellulosic composition is applied to a surface of the paper coated substrate using an extruder and, during or after volatilization of a portion of the volatilizable solvent during coating of the substrate with the cellulosic material, the cellulosic material is suitably-molded or embossed, such as by applying a suitable pressure, e.g., about 10 to about 60 psig, preferably about 20 to about 40 psig. to the composition using an embossing wheel 20 for imparting a suitable pattern in the surface of the cellulosic composition 18, as shown in FIG. 1. Generally, the cellulosic composition 18 is extruded in a layer over at least one surface of the paper coated substrate in a thickness that may vary from about 1/32 inch to about 1 inch, preferably about 1/16 inch to about ¾ inch depending upon the depth of pattern desired in the cellulosic material layer 18.

### PAPER ADHESIVES

Any adhesive capable of adhering a paper sheet to a substrate 12 can be used in accordance with both embodiments of the manufacturing methods described herein. The preferred adhesives, however, are hot melted adhesives particularly, resins such as vinyl acetate, hot melt adhesives, polyurethane hot melt adhesives, and may contain a small portion of 1 to 10% of a tacifying adhesive such as methylene bisphenyl isocyanate. One suitable hot melt adhesive is obtained from Reichhold Chemicals, Inc. in Research, Triangle Park, N.C. as swift 2H669 and includes about 10% of a paraffin wax. Other suitable hot melt adhesives obtained from Reichhold Chemicals, Inc. include EVER-LOCK 2U116, EVER-LOCK 2U132-each containing about 99% polyurethane polymer and 2 to 3% methylene bisphenyl isocyanate and Curalean 131-A polyurethane hot melt adhesive containing 94 to 95% polyurethane resin and about 5 to 6% aliphatic amines. The hot melt adhesive can be applied to the undersurface of the paper layer 14 or to the outer surface of the underlying substrate 12 and can be applied in any manner capable of completely coating either the undersurface of the paper 14 or the outer surface of the substrate 12 on all surfaces to be coated with the paper layer 14. Suitable application techniques include brush application, spray application, gravure coating methods and the like.

### DECORATIVE OUTER COATINGS

In one embodiment, after embossing the cellulosic composition 18 on at least one surface of the paper layer 14, as shown in FIG. 1, and after volatilization of the volatilizable solvents out of the cellulosic layer 18, the entire article or at least the intended visible surfaces thereof are then overcoated with a decorative coating, particularly a paint or a powder coating. The decorative coatings can be brush applied, gravure coated, spray applied, electrostatically deposited, or otherwise coated over the article 10. Preferred decorative coatings include the following.

Metallic powder coatings can be applied, for example, by powder coating guns, and provide excellent results, particularly when applied through a metallic powder application nozzle such as the flat-spray type nozzle 22 (FIG. 2) having an aerated impact disc 24 to provide an even cloud pattern of the powder coatings, as shown in FIG. 2. The metallic powder coating materials are provided in custom colors, fluorescent colors, hammertones suitable for exterior applications, “antico” powder coatings for simulating natural stone and oxidized copper to provide a particularly decorative finish. These powder coatings are also available in various textures and matte finishes in numerous colors including matte semi-gloss, fine texture, rough texture, glossy and rough texture matte, glitter coatings, e.g., gold, silver, red, blue, green, twilight, clear glossy, silver copper, gray, black, and the like. Suitable powder coatings can be obtained from Sherwin Williams Corporation, particularly those identified by the trademark POWDURA special effect coatings. Similarly, such POWDURA special effect coatings can be obtained in spice powder coatings that are multi-color powders that can be applied with a single application and top-coated with clear powder for additional finish performance. Each of these powder coatings include various film forming materials therewith, such as epoxy resins, hybrid resins, polyester urethanes, and the like. Other suitable powder coatings can be obtained from Roman & Hass, Morton Powder Coatings under the trademark LAMINEER which are solid thermosetting powder coatings that are spray applied and are intended for natural wood or fiberboard substrates, but, to date, are not intended for paper surfaces. These LAMINEER coatings are also available in various colors, glosses, and textures and provide the same visible surface finish over both the cellulosic composite material and the paper outer surfaces of the articles 10.

Additionally, any oil-based or water-based paints available for coating wood-based materials function to impart a decorative, pleasing surface finish over both the cellulosic composite material and/or the paper outer layer of the articles 10 while providing a non-differentiatable surface finish over the cellulosic composite material and/or the paper overlay of the articles 10.

The following examples provide details of the manufacturing methods in producing the articles 10 of both embodiments described herein.

### EXAMPLE 1

Start with medium density fiberboard molder machine that uses high speed knifes to cut into the MDF, and profile out the MDF board. After milling the MDF, the lamination of the profile is achieved by laminating uncoated kraft paper onto it. Lamination: paper is wrapped around the MDF profile, the paper is secured thereto with a ultraviolet curable hot melt adhesive which is cured as it passes though a U.V. light. This process is done with a lamination machine that surrounds the MDF board with laminate (paper wrap, or ecological paper) material, around a portion of, or the entire MDF board. After laminating, the molding will then be taken over to the cellulosic composition (Compo) extruder where the cellulosic composition is extruded over a surface of the paper-covered board. An embossed or debossed pattern is pressed onto at least one surface of the paper laminated MDF paper.

After the compo is applied and dried, it is taken over to a cross groover and/or miter saw for frame cutting; then the cut pieces are taken to a joiner/under pinning machine for assembly. The under pining machine or V-nail machine secures the cut pieces with nails, to complete an assembled shell, or frame. The frame shell will then be coated with decorative coating material, e.g., a powder coating wherein metallic powder-based particles are sprayed over at least the outer (visible) surfaces of the frame shell. The frame shell is preheated to about 185° F. to about 375° F., preferably about 200° F. to about 235° F. to “magnetize” the laminate paper that surrounds the MDF board. The powder attaches itself to the Compo and paper, and then it goes through a heated oven at a temperature in the range of about 285° F. to about 350° F., preferably about 300° F. to about 400° F., for 20-30 minutes until cured. Once cured, the powder coating meshes itself to the paper, leaving a homogeneous finished surface on top of both the Compo and paper material.

### EXAMPLE 2

Start with medium density fiber board (MDF). Mill the medium density fiber board into a profile, and laminate paper to its outer surface, as in Example 1. After laminating, the molding will be taken to the cross grooving and or miter saw for frame cutting, then to the joiner/under pinning machine for assembly. The under pining machine or V-nail machine secures the cut pieces with nails, to complete an assembled shell, or frame. The frame shell will then be preheated to about 185° F. to about 375° F., preferably about 200° F. to about 235° F. and, within this temperature range, will be coated with a metallic powder coating wherein metallic powder-based particles are sprayed over at least the outer (visible) surfaces of the frame shell. The frame shell is preheated to “magnetize” the laminate paper that surrounds the MDF board. The powder attaches itself to the paper surprisingly well, and then it goes through a heated oven at a temperature in the range of about 285° F. to about 350° F., preferably about 300° F. to about 400° F., for 20-30 minutes until cured. Once cured, the powder coating meshes itself to the paper, leaving a homogeneous finished surface on top of the paper.

1. An article of manufacture comprising
a shaped substrate having an outer surface, said shaped substrate having an uncoated paper layer adhered to at least a portion of said outer surface of said substrate;
an embossed layer of a composition comprising cellulosic fiber particles, an adhesive for said cellulosic particles, and a volatilizable solvent adhered to at least one outer surface of said paper layer; and
a decorative coating surface finish applied over said embossed layer and at least a portion of said paper layer.

2. The article of claim 1, wherein the cellulosic particles comprise wood dust.

3. The article of claim 1, wherein the paper layer is heated to a temperature of about 185° F. to about 375° F. prior to applying the decorative coating surface finish.

4. The article of claim 3, wherein the paper layer is heated to a temperature of about 200° F. to about 235° F. prior to applying the decorative coating surface finish.

5. The article of claim 1, wherein the composition layer is applied over the paper layer in a thickness of 1/32 inch to 1 inch.

6. The article of claim 5, wherein the composition layer is applied over the paper layer in a thickness of 1/16 inch to ¾ inch.

7. The article of claim 1, wherein the paper layer is Kraft paper.

8. The article of claim 1, wherein the shaped substrate is a material selected from the group consisting of a wood-based board, polyurethane foam, milled natural wood, metal, and plastic.

9. The article of claim 8, wherein the shaped substrate is a plastic selected from the group consisting of polyurethane, polyethylene, polypropylene, and nylon.

10. The article of claim 8, wherein the shaped substrate is a medium density fiberboard.

11. The article of claim 1, wherein the composition adhered to the uncoated paper layer comprises, by weight of the composition:
15%-40% cellulosic particles
40%-70% volatile solvent, and
5%-30% adhesive.

12. The article of claim 11, wherein the composition adhered to the uncoated paper layer comprises, by weight of the composition:
20%-35% cellulosic particles
45%-60% volatile solvent, and
10%-25% adhesive.

13. The article of claim 12, wherein the composition adhered to the uncoated paper layer comprises, by weight of the composition:
25%-35% cellulosic particles
50%-55% volatile solvent, and
10%-20% adhesive.

14. The article of claim 11, wherein the adhesive comprises polyvinylacetate.

15. The article of claim 1, wherein the composition adhered to the uncoated paper layer is applied with an extruder.

16. The article of claim 1, wherein the composition adhered to the uncoated paper layer is embossed during or after volatilization of a portion of the volatilizable solvent.

17. The article of claim 11, wherein the adhesive is a hot-melt adhesive.

18. The article of claim 17, wherein the hot melt adhesive is a vinyl acetate resin hot melt adhesive or a polyurethane resin hot melt adhesive.

19. The article of claim 17, wherein the hot melt adhesive includes 1% to 10% by weight of a tackifying adhesive.

20. The article of claim 19, wherein the tackifying adhesive comprises methylene bisphenyl isocyanate.

21. The article of claim 20, comprising 2%-3% by weight methylene bisphenyl isocyanate.

22. The article of claim 17, wherein the hot melt adhesive includes paraffin wax.

23. The article of claim 1, wherein the decorative surface finish is applied by a method selected from the group consisting of brush coating, gravure coating, spray coating, and electrostatic deposition.

24. The article of claim 1 in the form of a picture frame comprising four of said articles attached together to form a rectangle.

25. An article of claim 1, shaped to form a molding selected from the group consisting of a wall molding, door molding, and crown molding.

26. The article of claim 1, wherein the decorative surface finish comprises a powdered coating composition containing a film forming material therein.

27. An article of manufacture comprising
a shaped substrate having an outer surface, said shaped substrate having an uncoated paper layer adhered to at least a portion of said outer surface of said substrate; and
a decorative metallic powder finish applied over and adhered to at least a portion of said paper layer.

28. The article of claim 27 in the form of a picture frame comprising four of said articles attached together to form a rectangle.

29. A method of manufacturing a decorative article comprising:
shaping a substrate to form a molding profile;
adhering an uncoated paper sheet to an outer surface of said shaped substrate;
applying a composition layer including cellulosic particles, an adhesive for said cellulosic particles, and a volatilizable solvent on at least one outer surface of said paper sheet;
embossing said composition layer to form a decorative pattern therein; and
applying a decorative layer or film over the embossed, decorative pattern and at least a portion of said paper sheet.

30. The method of claim 29, wherein the cellulosic particles comprise wood dust.

31. The method of claim 29, wherein the paper layer is heated to a temperature of about 185° F. to about 375° F. prior to applying the decorative coating surface finish.

32. The method of claim 31, wherein the paper layer is heated to a temperature of about 200° F. to about 235° F. prior to applying the decorative coating surface finish.

33. The method of claim 29, wherein the composition layer is applied over the paper layer in a thickness of 1/32 inch to 1 inch.

34. The method of claim 33, wherein the composition layer is applied over the paper layer in a thickness of 1/16 inch to ¾ inch.

35. The method of claim 29, wherein the paper layer is Kraft paper.

36. The method of claim 29, wherein the shaped substrate is a material selected from the group consisting of a wood-based board, polyurethane foam, milled natural wood, metal, and plastic.

37. The method of claim 36, wherein the shaped substrate is a plastic selected from the group consisting of polyurethane, polyethylene, polypropylene, and nylon.

38. The method of claim 36, wherein the shaped substrate is a medium density fiberboard.

39. The method of claim 29, wherein the composition adhered to the uncoated paper layer comprises, by weight of the composition:
15%-40% cellulosic particles
40%-70% volatile solvent, and
5%-30% adhesive.

40. The method of claim 39, wherein the composition adhered to the uncoated paper layer comprises, by weight of the composition:
20%-35% cellulosic particles
45%-60% volatile solvent, and
10%-25% adhesive.

41. The method of claim 40, wherein the composition adhered to the uncoated paper layer comprises, by weight of the composition:
25%-35% cellulosic particles
50%-55% volatile solvent, and
10%-20% adhesive.

42. The method of claim 39, wherein the adhesive comprises polyvinylacetate.

43. The method of claim 29, wherein the composition adhered to the uncoated paper layer is applied with an extruder.

44. The method of claim 29, wherein the composition adhered to the uncoated paper layer is embossed during or after volatilization of a portion of the volatilizable solvent.

45. The method of claim 39, wherein the adhesive is a hot-melt adhesive.

46. The method of claim 45, wherein the hot melt adhesive is a vinyl acetate resin hot melt adhesive or a polyurethane resin hot melt adhesive.

47. The method of claim 45, wherein the hot melt adhesive includes 1% to 10% by weight of a tackifying adhesive.

48. The method of claim 29, wherein the decorative surface finish is applied by a method selected from the group consisting of brush coating, gravure coating, spray coating, and electrostatic deposition.

49. The method of claim 29, wherein the decorative surface finish comprises a powdered coating composition containing a film forming material therein.

50. A method of manufacturing a decorative article comprising:
shaping a substrate to form a molding profile;
adhering an uncoated paper sheet to an outer surface of said shaped substrate;
pre-heating the paper-coated substrate to a temperature in the range of about 185° F. to about 375° F.; and
applying a decorative metallic powder layer or film over at least a portion of said pre-heated paper sheet.
